(19) United States
(12) Patent Application Publication
(10) Pub. No.: US 2022/0038800 A1
(43) Pub. Date: Feb. 3, 2022

(54) QUICK RELEASE MOUNTING MECHANISM FOR A PORTABLE SPEAKER SYSTEM

(71) Applicant: Jamstack, Toronto (CA)

(72) Inventors: Chris James PRENDERGAST, Toronto (CA); Paul WOJCIECHOWSKI, Mississauga (CA)

(21) Appl. No.: 17/392,820

(22) Filed: Aug. 3, 2021

Related U.S. Application Data
(60) Provisional application No. 63/060,184, filed on Aug. 3, 2020.

(51) Int. Cl. H04R 1/02; F16M 13/02; G10D 3/00; G10H 3/12

(52) U.S. Cl. CPC H04R 1/02; G10H 3/12; G10D 3/00; F16M 13/02

(57) ABSTRACT

Various methods are presented that facilitate the connection of a speaker system to a separate functional system. In some embodiments, the connection is made through a male and female connector designed to twist into a locking position. In other embodiments, the connection is made by a guided connection with beveled edges to facilitate correct alignment of the speaker system. In still other embodiments, the connection includes mechanical locking mechanisms with a quick disconnect feature. In other embodiments, the connection also facilitates transmission of electrical signals through the connector.

### CROSS REFERENCE TO RELATED APPLICATIONS

The application claims priority and the benefit of U.S. Provisional Application Ser. No. 63/060,184, entitled “A QUICK RELEASE MOUNTING MECHANISM FOR A PORTABLE SPEAKER SYSTEM”, filed on Aug. 3, 2020, the disclosure of which is incorporated herein by reference in its entirety.

### BACKGROUND

Embodiments described herein relate to a system and method to attach a portable speaker system to a musical instrument mechanically and electrically.

With recent advantages in battery technology and speaker technology, high performance, small portable and self-powered speaker systems have become ubiquitous for many applications. This new functionality has allowed people to enjoy preprogrammed music through easy to carry speaker systems. Typically, the audio source is an application on a smartphone, and the connection to the speaker system is either direct connect by a wire or jack, or through a wireless protocol such as Bluetooth. The sound amplification systems for electrical and electronic musical instruments have not enjoyed similar advancements that enable easy portability. Many of the systems are very large, heavy, and require external power sources to operate.

To enjoy the same portability for electrical and electronic musical instruments, an attachment mechanism is required that will couple the speaker system and the musical instrument together, so that the musician can move about freely. It is also important that the attachment is not harmful to the instrument, and that the attachment provides a secure and mechanically robust connection that will tolerate player movements. The connection system must also be able to attach and detach quickly, so that the speaker can be attached to different mounting places, or configured for a performance with a musical instrument quickly. It would also be advantageous if the connecting mechanism could provide an electrical signal interface and/or power interface to further minimize the steps involved in connecting an electrical or electronic musical instrument to the speaker system.

In some instances, a quick release system guides the mechanism by providing guiding features such as beveled edges or alignment features. In some embodiments, the mechanism then locks in place and can be released by a single gesture action such as a button push/pull or twisting of the speaker.

### SUMMARY

Various methods are presented that facilitate the connection of a speaker system to a separate functional system such as a guitar, bicycle, stand assembly or similar system. In some embodiments, the connection is made through a male and female connector designed to twist into a locking position. In other embodiments, the connection is made by a guided connection with beveled edges to facilitate correct alignment of the speaker system. In still other embodiments, the connection includes mechanical locking mechanisms with a quick disconnect feature. In other embodiments, the connection also facilitates transmission of electrical signals through the connector.

In some embodiments, the speaker system has a permanent feature in the geometry such that it facilitates a quick release attachment to a bracket. This bracket can be attached to vehicles, such as bicycles, golf carts and boats as well as scaffolding, and poles such as found on decks and railings. The bracket can also be used with a tripod or other professional audio/video gear.

### BRIEF DESCRIPTION OF THE DRAWINGS

FIG. 1A is a perspective view of a quick release coupling mechanism disconnected to a portable speaker system.

FIG. 1B is a perspective view of a quick release coupling mechanism connected to a portable speaker system.

FIG. 1C is a perspective view of an alternate quick release coupling mechanism connected to a portable speaker system.

FIG. 2 is a perspective view of the portable speaker side of the quick disconnect coupling mechanism with guiding features and a click retention mechanism.

FIG. 3A is a perspective view of a quick release coupling mechanism.

FIG. 3B is an alternate perspective view of a quick release coupling mechanism.

FIG. 4 is a perspective view of the connecting mechanism of a quick release coupling mechanism.

FIG. 5 is a perspective view of the portable speaker system including the mating shape for the slot described in FIG. 4.

FIG. 6 is a diagram illustrating a portable speaker system in a disconnect position with a quick release coupling mechanism.

FIG. 7 is a diagram illustrating a portable speaker system connected to a vertical stand.

FIG. 8 is a diagram illustrating a portable speaker system connected to a bicycle.

FIG. 9 is a diagram illustrating a portable speaker system connected to an electric guitar.

FIG. 10 is a diagram illustrating the details of a combined mechanical and electrical interface using a twist captivation system.

FIG. 11 is a diagram illustrating several sources that could be connected through the bracket to the speaker enclosure.

FIG. 12A is a line drawing of a non-compressed perspective view of a speaker enclosure wall mount.

FIG. 12B is a line drawing of a compressed perspective view of a speaker enclosure wall mount.

FIG. 12C is a line drawing of a side view of a speaker enclosure wall mount.

FIG. 12D is a line drawing of a top view of a speaker enclosure wall mount.

### DETAILED DESCRIPTION

Embodiments described herein relate to a system and method to attach a portable speaker system in a quick and releasable way, to various modular mounting brackets. The speaker enclosure itself has geometry and features such that it can be married to various brackets so that the mobile speaker can be placed in convenient and accessible locations. This geometry on both the enclosure and the various modular brackets are specifically designed to be released with one action (such as twisting or button push) and also handle the specific requirements of mobile speaker systems such as inhibiting vibration, passing audio signals through the mechanism itself, or charging the onboard speaker's battery. In addition, provided features in the connection mechanism provide a large contact surface area to provide stability to the connection, minimizing undesirable rocking or rotational movement between the speaker system and the bracket to which it is attached.

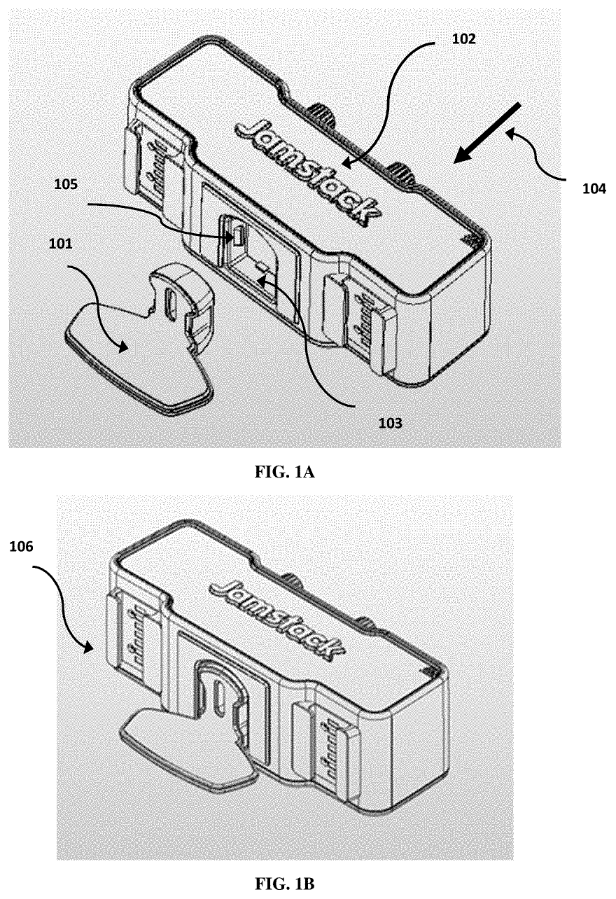

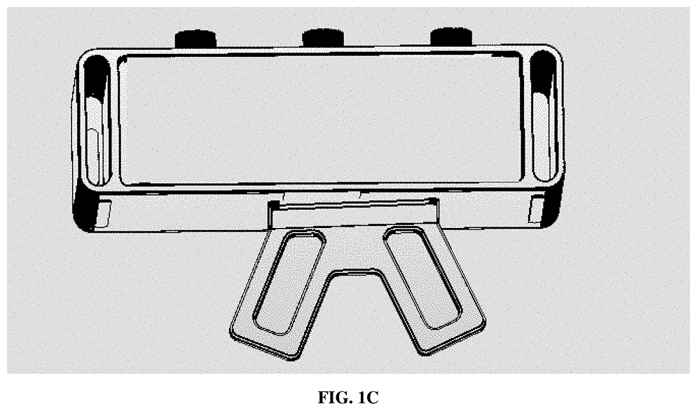

FIG. 1A is a perspective view of a quick disconnect coupling mechanism with guiding features and a click retention mechanism in a disconnected position. The guitar mounting bracket 101 is mounted to a musical instrument, in this example to a guitar. The flange shown rests alongside the back of the guitar, to prevent unintentional rotation of the bracket about the screw mounting axis. The mounting bracket is secured with a mounting screw through the hole shown in the bracket. This bracket is configured to use the same mounting screw and mounting screw hole that would normally fix the guitar strap peg (not shown) to the guitar. This strategy advantageously prevents the need for any additional modifications or the creation of any additional mounting holes on the instrument.

The mounting bracket, in this embodiment, is shaped to be the male shape that corresponds to the female shape 103 fixed into the housing of the speaker. The male bracket shape is generally tapered so that if the speaker 102 and the bracket are misaligned during the coupling process that the tapering will encourage proper alignment of the speaker and bracket. The speaker and bracket mating shape are asymmetrical about at least one axis so as to prevent unintentional coupling in unintentional positions. In this case, the bracket is generally square, but has a domed feature near the top of the bracket to prevent misalignment.

As for the coupling operation, as the speaker is moved along vector 104 towards the bracket 101 the previously mentioned tapering of both the male and female sides of the interface encourage alignment so that the parallel faces of the female aperture 103 and the bracket 101 will meet. In addition, the retaining element 105 is moveable. In this embodiment, there are two retaining elements, one on each side of the female mating shape. The retaining elements can withdraw into the housing and are also spring loaded such that they will protrude from the speaker enclosure when the bracket is fully inserted. In one embodiment springs are used to spring load the retaining elements, but this function can be accomplished by several mechanisms including magnets, springy foam, or mechanical deflection. The retaining elements function as a captivation mechanism. This captivation mechanism ensures that once coupled, the speaker is captivated onto the bracket. An advantage of using spring loaded retaining elements is that the user experiences tactile feedback indicating that the coupling is secure. Alternate types of captivation mechanism can also be used, including bayonet type mountings, mechanical slide mechanisms, screw captivation mechanisms, or lever captivation mechanisms.

FIG. 1B is a perspective view of a quick release coupling mechanism connected to a portable speaker system. In this drawing the speaker system is shown fully engaged 106 to the bracket. The captivation mechanisms are extended from the speaker housing and thus preventing the bracket and speaker from disengaging.

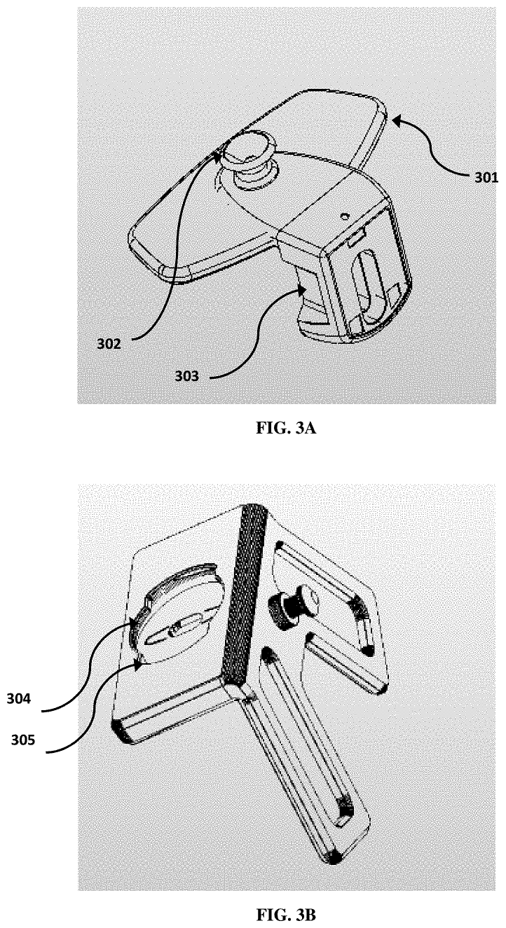

FIG. 1C is a perspective view of an alternate bracket for a quick release coupling mechanism connected to a portable speaker system. In this bracketing system, the bracket assembly has a wider stance, for situations in which additional mechanical stability against rotation about the mounting axis is required. Further details of this mounting bracket assembly will be shown in FIG. 3B.

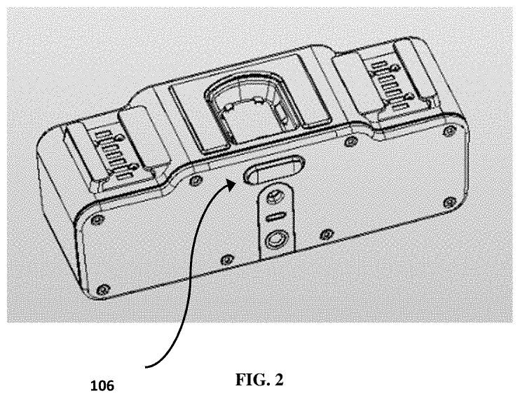

FIG. 2 is a perspective view of the portable speaker side of the quick disconnect coupling mechanism with guiding features and a click retention mechanism. An important feature of the quick disconnect system is a mechanism for releasing the coupling between the bracket and the speaker. The quick release button 106 is shown in this drawing. When pressed in, the quick release button engages an internal slide mechanism that couples to the two captivation mechanisms, forcing them into an internal cavity of the speaker housing. The design of this internal mechanism is not shown, and may be accomplished with one of many well-known techniques.

FIG. 3A is a perspective view of a quick release coupling mechanism 301. Illustrated in this drawing is how the guitar strap post 302 is attached to the bracket, permitting the continued use of a guitar strap while the bracket and/or the speaker are fixed to the guitar. Also shown in greater detail are the slots 303 that the retaining elements 105 protrude into to captivate the bracket to the speaker.

FIG. 3B is an alternate perspective view of a quick release coupling mechanism. The asymmetrical winged slot is fashioned to accept a mating element from the speaker. The recession of slot consists of a circular center area 304 with two additional apertures 305 to accept the insertion of flanges from the mating component.

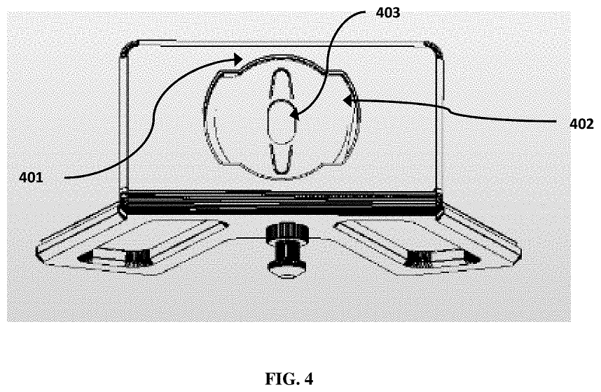

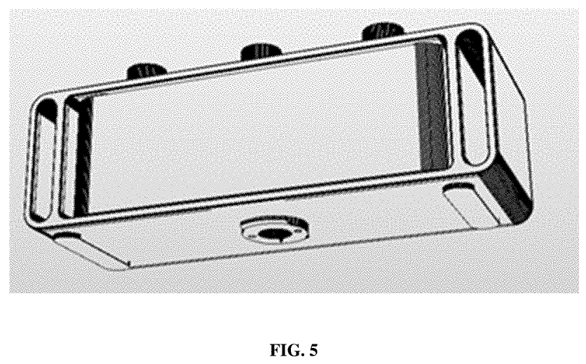

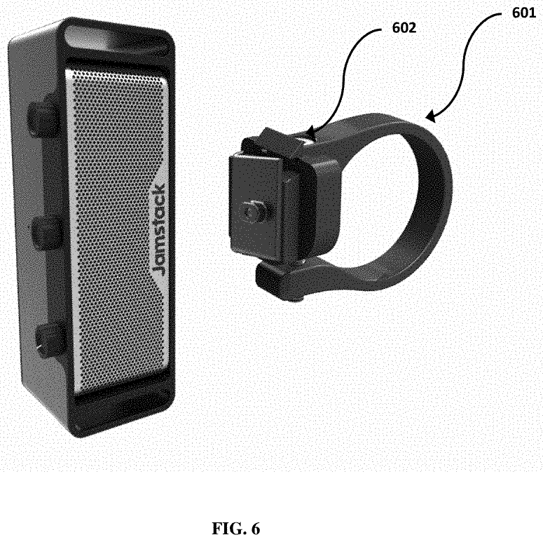

FIG. 4 is a perspective view of an alternate embodiment of a quick release coupling mechanism. This view shows a top view of the asymmetrical winged slot described in FIG. 3B. The slot is constructed such that a mating shape can be inserted into the slot, then rotated about the mounting axis 403 such that the tabs occupying the sides of the aperture 402 can be rotated to be under section 401, thus captivating the bracket to the speaker.

FIG. 5 is a perspective view of the portable speaker system including the mating shape for the slot described in FIG. 4. The tabs protrude from the mating shape to allow them to lock under the sides of the aperture 402.

FIG. 6 is a diagram illustrating a portable speaker system in a disconnect position with a quick release coupling mechanism that is capable of connecting to round or elongated members. In this embodiment, a bracket mount is provided 602 to wrap around and semi-permanently mount to a member such as a bicycle tube or a mounting stand by encircling the member and applying constrictive force with the screw 602. With the bracket mount mounted to the member, the speaker is then connected with a quick disconnect mechanism to the bracket. Any one of a number of quick disconnect mechanisms can be used. Particularly advantageous are mechanisms that would be common between multiple uses, for example using compatible quick disconnect mechanisms for the bracket connected to a guitar and for the bracket connected to a bicycle, and a bracket connected for use with a home stereo system.

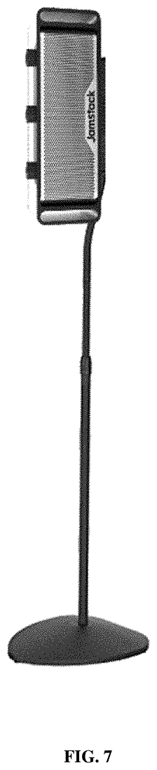

FIG. 7 is a diagram illustrating a portable speaker system connected to a vertical stand. This figure illustrates an applied use of the bracket connection mechanism shown in FIG. 6. In such an application, the connector can provide power to recharge the internal battery of the speaker. The music signal can be provided by an electrical wire or by a wireless signal such as Bluetooth. This embodiment provides an elegant and practical method for charging the speaker system, while simultaneously adding functionality to a music reproduction system, for example by providing additional channels to a multi-channel music reproduction system.

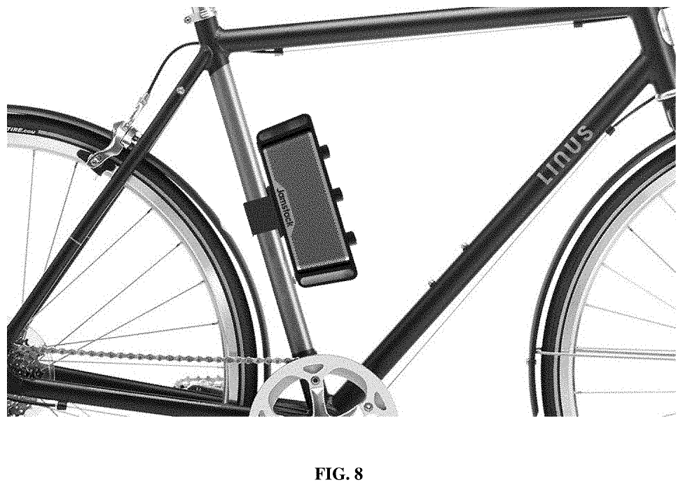

FIG. 8 is a diagram illustrating a portable speaker system connected to a bicycle. This figure illustrates an applied use of the bracket connection mechanism shown in FIG. 6. In this example, the speaker system is connected to a bracket via a quick disconnect system. This application provides an effective way to expand the scope of use of the speaker to beyond use with a musical instrument. The music signal in this application would be most advantageously transmitted wirelessly from a music player device, such as a mobile phone.

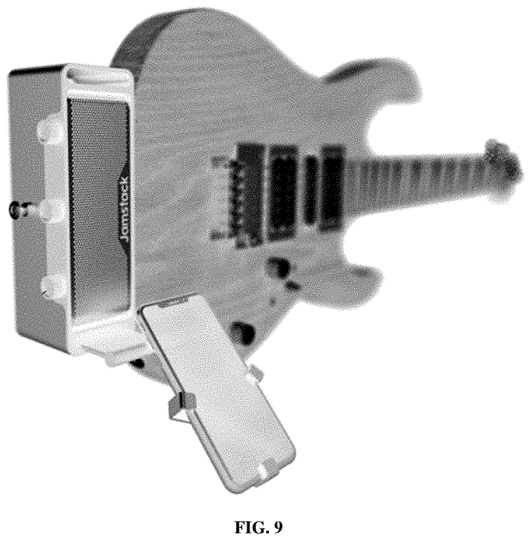

FIG. 9 is a diagram illustrating a portable speaker system connected to an electric guitar. In this example, a detachable secondary bracket attaches a mobile phone to the speaker system. The mobile phone in this application can have several functions including playing backing tracks for the guitarist, displaying music for the guitarist, displaying stage directions or set lists, or processing the signal from the guitar. In the example of processing the signal from the guitar, modern mobile phones have sufficient processing power to enhance or modify the sound of a guitar or other electrical instrument in real time. The signal from the electrical instrument is routed into an input of the mobile phone, and an output from the mobile phone is routed to the speaker. The signal to the speaker can be a mix of the original signal from the instrument, a modified signal based on the original signal from the instrument, and other signals, such as recorded tracks or other accompaniment. For convenience, the signal from the instrument, the signals to the mobile phone, and the signal to the speaker can be routed through the quick disconnect bracket to minimize the time and complexity to make the connections.

While a mobile phone is a preferred embodiment, several different types of devices could be used for the signal processing functions, including dedicated processing modules, analog modules, DSP modules, tablets, or other general or special purpose sound processing modules.

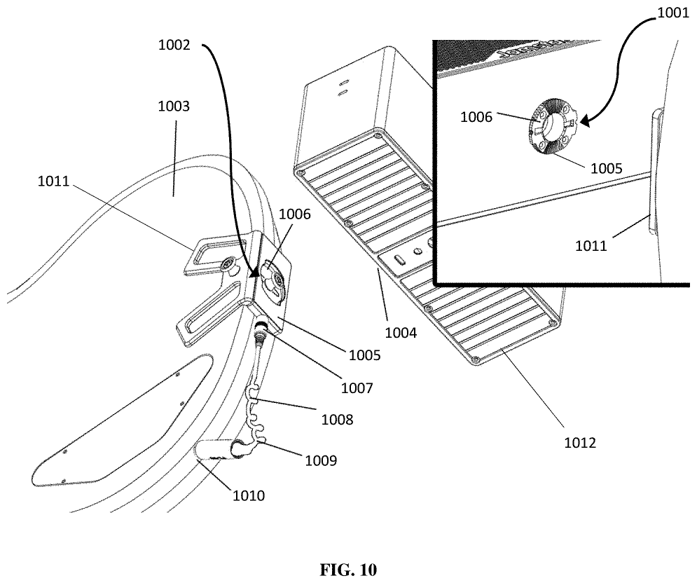

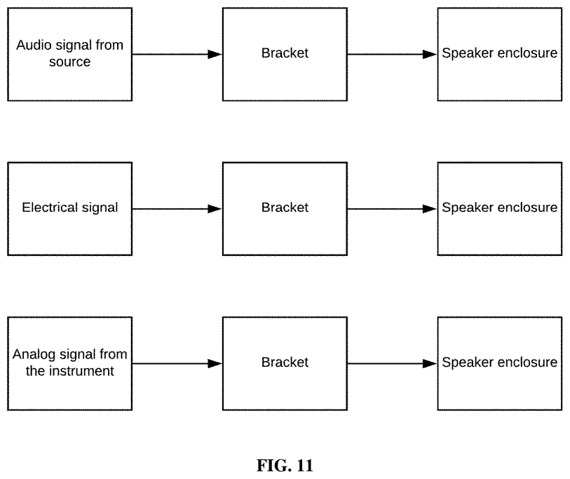

FIG. 10 is a diagram illustrating the details of a combined mechanical and electrical interface using a twist or rotational captivation system. The mechanical connection details are the same as illustrated in FIGS. 3B, 4 and 5. Additionally illustrated is an electrical connection system that enables an electrical connection simultaneously with the mechanical captivation system between a musical instrument (e.g., electrical guitar 1003) and amplifier 1004.

According to FIG. 10, a multi-conductor ring 1001 is shown that provides electrical connection between the guitar bracket 1011 and the speaker 1012. For simplicity two conductors are shown, but the concept is generalizable to any number of conductors for additional applications. Ring 1001 is formed of two exposed conductors arranged in a generally circular shape. The ring is segmented into multiple segments, in this example, two. When the bracket 1011 and the speaker 1012 are mounted and aligned, protruding conductive features 1002 on the mating side of the bracket complete a circuit for one or more conductors.

These conductive features could be small metal spring-loaded spheres, leaf spring contacts, or other conductive elements. Advantageous electrical signals that could be coupled through one or more conductors are power, musical instrument signal, processed musical instrument signal, signals representing the settings of a control module mounted on the instrument, status signals, proper connection signals, signals representing the control or performance settings of musical instruments, microphone signals, speaker configuration signals, accompaniment signals or signals from additional signal processing devices attached to the instrument.

While this preferred embodiment uses analog electrical signals, digital signals, optical signals or some combination may also be used to accomplish similar advantages. In the shown example, a flexible coiled cable 1008 is connected to a jack on the bracket via a 2.5 mm connector 1007. The other end of the cable would be connected to a signal coming from the musical instrument and may be connected to a ⅛″ 90-degree mono connector 1009 via connector jack 1010. In further embodiments, the musical instrument may also connect to a ¼″ mono connector. The electrical signals from the jack are then connected to the protruding conductive features 1002 of the guitar bracket 1011. In this case, the signals are ‘signal’ 1005 and ‘ground’ 1006 that are the standard signals used to connect a guitar to the input of an amplifier. When the speaker is coupled to the bracket, these electrical signals are connected to the ring 1001. The signals are then connected to the speaker for further processing, amplification, and translation to sound energy. Connectors 1007, 1009 and 1010 may be chosen as straight, 90-degree or other angled connectors, and may be 2.5 mm, 3.5 mm, 1/16″, ⅛″, ¼″ or some other size.

Advantageously, the ring conductor provides constant electrical connection from the time that the connector is first coupled, through the entire rotation to the locked position, thus providing better signal continuity through the mounting and dismounting processes. A further advantage is that the contact surfaces wipe against each other. This provides an electrical advantage by wiping off oxidization and dirt from the contact area and providing a better metal to metal contact. This, in turn, lowers the resistance and reliability of the connection.

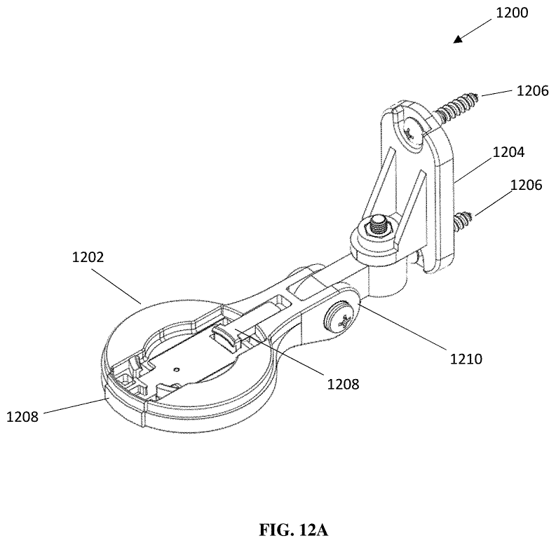

FIG. 11 is a diagram illustrating several illustrative sources that could be connected through the bracket to the speaker enclosure. In the example in FIG. 11, multiple brackets are configured to input an audio signal from source, an electrical signal, or an analog signal from an instrument. The bracket connection mechanism provides connection to multiple types of signal source, provides appropriate multifunctional configuration, and provide a quick connect method of using a speaker device in multiple applications. For example, when connected to a guitar bracket, certain connectors on the connector interface may be selected by the speaker system and amplified, and signal processing to a mobile phone may be enabled through another set of conductors on the same interface. Similarly, the same speaker system when connected to a home stereo would use different connectors to maintain charge of the internal battery, use a conductor to determine if in the ‘right’ or ‘left’ position in the listening field, and select the appropriate signal for that position.

In further embodiments, the opposite direction of operation can also be considered. For example, connection from Bluetooth to speaker to bracket to external sound source. A further example includes speaker to bracket to powering something else.

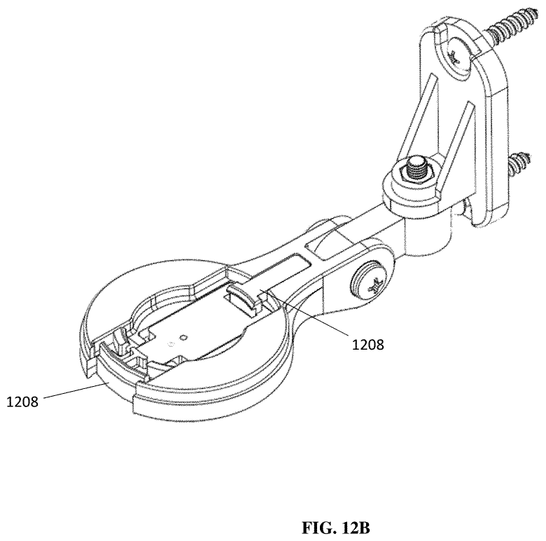

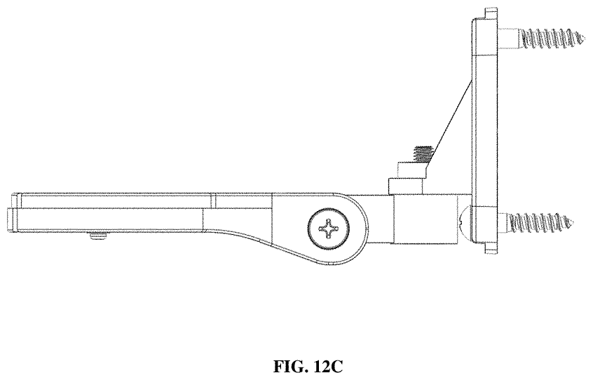

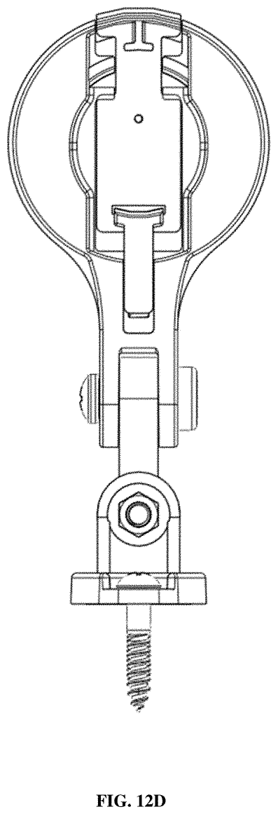

FIGS. 12A to 12D are diagrams illustrating a wall mount speaker enclosure. FIG. 12A is a line drawing of a non-compressed perspective view of a speaker enclosure wall mount. According to FIG. 12A, wall mount speaker enclosure 1200 comprises speaker mount 1202 and wall bracket 1204. Wall bracket 1204 further comprises screws 1206 that enable it to be securely attached to a wall. Push latch 1208 on speaker mount 1202 are compressible to securely engage a portable speaker. FIG. 12A is shown with push latch 1208 in a non-compressed state. FIG. 12A also contains a flexible hinge 1210 enabling the wall mount speaker enclosure to rotate up to 180 degrees.

FIG. 12B is a line drawing of a compressed perspective view of a speaker enclosure wall mount, shown in FIG. 12B with push latch 1208 in a compressed state.

FIG. 12C is a line drawing of a side view of a speaker enclosure wall mount. FIG. 12D is a line drawing of a top view of a speaker enclosure wall mount. According to FIG. 12, the wall mount accepts the twisting style mechanism, but actuates as a push mechanism instead, as a wall mounting typically requires less security than mounting on an instrument or vehicle, and wall mounting may not provide enough room to twist the speaker.

In further embodiments, the vibration between the speaker and the bracket is reduced by compressing a pliable material as the mechanism is engaged. In one instance the twisting force is also translated into linear force bringing the enclosure and brackets together thus compressing the pliable material. In another instance, the push snap bracket is not engaged until the pliable material is significantly compressed. The compressed material acts to inhibit vibration of both the bracket as well as the speaker enclosure and buffers vibration between both systems.

In further embodiments, the compressible material is selected so as to enhance the mechanical coupling between the speaker system and the connected bracket. An appropriate durometer is selected for the pliable material to allow for the passing of specific frequencies, for example the frequencies corresponding to the strings on a guitar. This in turn, impacts the apparent ‘resonance’ of the instrument as vibrations from the speaker feedback mechanically to the sound generation of the strings. This positive feedback filter can thus be tuned by selection of different pliable materials. The technique of controlling the acoustic coupling between the speaker system and a bracket can also be used to optimize the sound characteristics of any of the other embodiments mentioned before, and in particular connection to devices that may operate in whole or in part as a passive sound radiation system. In some embodiments, the compressible material can be on either or both sides of the bracket.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

1. A coupling system that connects a speaker system to a musical instrument comprising:
a mounting bracket releasably mounted to the musical instrument, the mounting bracket having a base piece and a perpendicular mounting piece (male shape);
a mounting aperture (female shape) mounted onto the speaker system;
a movable retaining element on the mounting aperture that mates with the mounting bracket and retains the mounting bracket in place;
a release mechanism for disconnection of the mounting bracket from the speaker system;
wherein the mounting bracket and the mounting aperture engage with perpendicular coupling force only; and
wherein the mounting bracket and the mounting aperture disconnect from each other by activating the release mechanism.

2. The coupling system of claim 1 wherein the musical instrument is an acoustic or electric guitar.

3. The coupling system of claim 1 where the mounting piece of the mounting bracket has slots that captivate the bracket to the speaker system on rotation of the speaker system.

4. The coupling system of claim 1 wherein the mounting bracket mounts to the musical instrument with a screw on the same axis as a guitar strap peg.

5. The coupling system of claim 1 wherein the mounting bracket includes a flange resting alongside the back of the guitar to prevent unintentional rotation of the bracket about the screw mounting axis.

6. The coupling system of claim 1 where the retaining elements are engaged by materials selected from a list consisting of loaded springs, magnets, springy foam, and mechanical deflection material.

7. The coupling system of claim 1 where the mounting bracket has a wider stance, for additional mechanical stability against rotation about the mounting axis.

8. The coupling system of claim 1 wherein the release mechanism on the speaker system, when activated engages an internal slide mechanism that couples to the captivation mechanisms, forcing the captivation mechanisms into an internal cavity of the speaker housing.

9. A coupling system that connects a speaker system to a musical instrument comprising:
a mounting bracket releasably mounted to the musical instrument, the mounting bracket having a base piece and a perpendicular mounting piece (female shape);
a mounting aperture (male shape) mounted onto the speaker system;
a mounting bracket further comprising an asymmetrical winged slot to accept a mating element from the speaker system;
wherein the asymmetrical winged slot consists of a circular center area with two additional apertures to accept insertion of flanges from the mating component on the speaker system; and
where the speaker system and musical instrument are securely coupled when the speaker system is rotated such that the flanges are within the apertures.

10. The coupling system of claim 9 wherein the male mounting piece and female mounting aperture further include a combined mechanical and electrical interface using a twist or rotational captivation system.

11. The coupling system of claim 9 wherein the female mounting aperture is a multi-conductor ring that provides electrical connection between the bracket and speaker.

12. The coupling system of claim 9 further comprising a multi-conductor ring having protruding conductor features on mating side of mounting bracket to complete a circuit.

13. The coupling system of claim 10 whereby the electrical interface includes conductive features from a list including metal spring loaded spheres, leaf spring contacts, and conductive foam.

14. The coupling system of claim 9 whereby the mounting bracket further comprises a flexible coiled cable connected to a jack on the bracket via a 2.5 mm connector.

15. The coupling system of claim 9 whereby the bracket connection system additionally facilitates connection of the speaker system (speaker enclosure) to an audio signal from a source electrical signal or analog signal from instrument.

16. A coupling system of claim 15 whereby the bracket connections system permits a single gesture disconnection.

17. A wall mounted coupling system that connects a speaker system to a musical instrument comprising:
a speaker mount assembly;
a push latch on the speaker mount that is compressible to securely engage to the speaker system; and
a wall bracket having a plurality of screws to secure the wall bracket to a wall.

18. The wall mounted coupling system of claim 17 further comprising a flexible hinge enabling the wall mount coupling system to rotate up to 180 degrees.

19. The wall mounted coupling system of claim 17 wherein the wall bracket is configured to attach to a tubular pole or a bicycle frame.
